(19) United States
(12) Patent Application Publication
(10) Pub. No.: US 2012/0216224 A1
(43) Pub. Date: Aug. 23, 2012

(54) METHOD AND APPARATUS FOR MANAGING TARGETED ADVERTISEMENTS FOR A LINEAR TELEVISION SERVICE

(75) Inventors: Priya Rajagopal, Ann Arbor, MI (US); Lei Cao, Singapore (SG); Ranjeet Kumar, Singapore (SG); Jiong Li, Singapore (SG); Mohammed Safiq Mohammed Iqbal, Singapore (SG); Hui Shen, Singapore (SG); Kok Meng Wong, Singapore (SG)

(73) Assignee: MOTOROLA MOBILITY, INC., Libertyville, IL (US)

(21) Appl. No.: 13/031,707

(22) Filed: Feb. 22, 2011

(51) Int. Cl. H04N 7/10

(52) U.S. Cl. 725/32

(57) ABSTRACT

A method and apparatus for managing targeted advertisements for linear television is provided herein. During operation a list of N channels are maintained. Advertisements for the N channels are downloaded and stored locally. The list of N channels will be dynamically updated with advertisements being added to, and removed from local storage.

### FIELD OF THE INVENTION

The present invention relates generally to managing targeted advertisements and in particular, to a method and apparatus for managing targeted advertisements for a linear television service.

### BACKGROUND OF THE INVENTION

Linear television (television) channels are multicast/broadcasted to the end users as is typically the case in fixed television environments or they may be unicast to individual clients as is typically the case in mobile television environments. Linear television service must support the ability to allow users to switch between channels including the option to “channel surf”, where the user may watch just a few segments of the channel before switching channels.

It is known to provide targeted advertisements to users that are inserted in linear television content. In such systems, a client device usually receives advertisements that can be tailored to a particular user. A client based approach to targeted advertisement insertion is the most effective way to handle linear television advertisements wherein the targeted advertisements are fetched and locally inserted at the client. In a client based Advanced Advertising solution, advertisements for linear television content are downloaded from a central server and displayed to the end user based on various targeting criteria, potentially overriding existing advertisement content and/or at other positions during the linear television program. Such systems include, but are not limited to the Society of Cable Engineers (SCTE) 130 (SCTE-130) for signaling advertising information, SCTE-35 for in-band advertisement marker identification and Cable Labs ADI 3.0 for out-of-band advertisement marker identification (NPT signaling).

When advertisements are fetched and stored locally, a problem exists in that the user equipment has limited storage capabilities. Because of this, only a limited number of advertisements can be locally stored. It becomes critical for the local storage to store advertisements that have a high probability of being viewed so that storage space is not wasted on advertisements that will not be viewed. Therefore, a need exists for a method and apparatus for managing targeted advertisements for a linear television service that locally stores advertisements that have a high probability of being viewed.

### BRIEF DESCRIPTION OF THE DRAWINGS

FIG. 1 is a block diagram showing hardware components of a switched digital video (SDV) system.

FIG. 2 is a flow chart showing the operation of the SDV system of FIG. 1.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. Those skilled in the art will further recognize that references to specific implementation embodiments such as “circuitry” may equally be accomplished via replacement with software instruction executions either on general purpose computing apparatus (e.g., CPU) or specialized processing apparatus (e.g., DSP). It will also be understood that the terms and expressions used herein have the ordinary technical meaning as is accorded to such terms and expressions by persons skilled in the technical field as set forth above except where different specific meanings have otherwise been set forth herein.

### DETAILED DESCRIPTION OF THE DRAWINGS

In order to alleviate the above-mentioned need, a method and apparatus for managing targeted advertisements for linear television is provided herein. During operation a list of N channels are maintained.

Advertisements for the N channels are downloaded and stored locally. The list of N channels will be dynamically updated with advertisements being added to, and removed from local storage.

By maintaining advertisements for N channels, overhead of re-fetching and re-processing advertisements when tuning back to a previously visited channel are eliminated. Additionally, because only advertisements for the N channels are being stored, the amount of storage needed is greatly reduced.

The present invention encompasses a method for managing targeted advertisements for a linear television service. The method comprises the steps of maintaining a list of N channels, providing the N channels to an advertisement server, receiving advertisements tailored to the N channels, and storing the advertisements along with their associated channel.

The present invention additionally encompasses a device comprising storage maintaining a list of N channels, wherein the list of N channels comprises a subset of all channels available. The device additionally encompasses an advertisement replacement detector providing the N channels to an advertisement server, receiving advertisements tailored to the N channels, and storing the advertisements along with their associated channel.

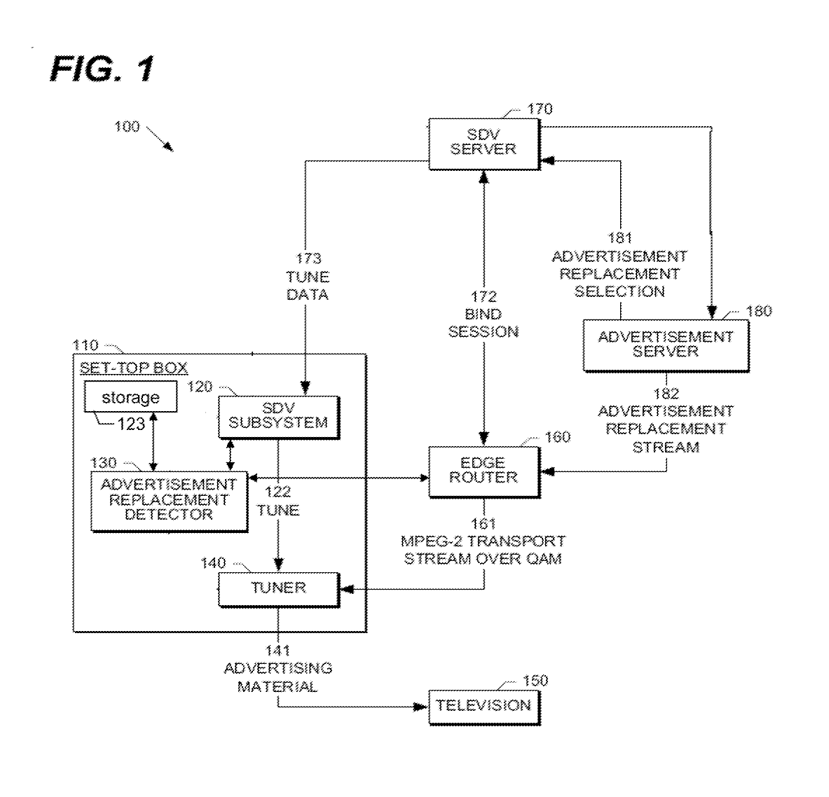

Turning now to the drawings, where like numerals designate like components, FIG. 1 is a block diagram showing hardware components of a switched digital video (SDV) system 100. SDV system 100 includes a set-top box 110, television 150, edge router 160, SDV server 170, and advertisement server 180. In one embodiment, a network (not shown), such as a hybrid-fiber coaxial (HFC) network, connects the set-top box 110 and the television 150 to the edge router 160, SDV server 170, and the advertisement server 180. In another embodiment, a network (not shown) connects the advertisement server 180 to the edge router 160 and SDV server 170.

The set-top box 110 is a computing device that connects the television 150 and an external signal source, turning the signal into a content stream that the television 150 displays. The set-top box 110 shown in FIG. 1 includes an SDV subsystem 120, advertisement replacement detector 130, tuner 140, and internal storage 123. Internal storage 123 preferably comprises storage such as, but not limited to a Serial ATA (SATA) hard disk drive, optical drive, Small Computer System Interface (SCSI) disk, flash memory, or the like, and is used to store advertisements.

The edge router 160 is a computing device that transfers data between a local area network and a wide area network, choosing the most effective paths to use when sending or receiving data. The edge router 160 shown in FIG. 1 includes quadrature amplitude modulators (QAMs) that enable the transmission of a multiplex of digital streams via a radio-frequency (RF) carrier.

The SDV server 170 is a computing device that receives channel change requests for switched content from the set-top box 110, binds that content to a session on the edge router 160 that is associated with a QAM feeding the service group for the set-top box 110, and responds to the set-top box 110 with the frequency and program number where the content may be found.

The system shown in FIG. 1 utilizes an SDV environment to send a targeted advertisement. In one embodiment, the targeted advertisement is a replacement for the primary network advertisement that is typically shown during a television program or between two television programs. In another embodiment the targeted advertisement does not replace an existing advertisement shown during a program, but simply fills time periods of program inactivity. One benefit of using the SDV environment to send targeted advertisements is that targeted advertisements are not required to be transmitted on the network in a continuous manner, and can be switched in based on an insertion decision made by the replacement detector 130. In this particular embodiment, advertisement server 180 provides advertisement replacement detector 130 with targeted advertisements particular to set-top box 110. These advertisements are then stored in storage 123.

Each targeted advertisement stored in storage 123 will be associated with a channel or channels. These advertisements will preferably be played only when watching the associated channel(s). Because of this, advertisements may be better tailored to programming that is currently being viewed. For example, an outdoor channel can have associated advertisements that relate to the outdoors. Such advertisements may include advertisements for hiking boots, hunting equipment, . . . , etc. In a similar manner, an exercising channel can have associated advertisements that relate to exercising. Such advertisements may include advertisements for weights, exercise equipment, . . . , etc.

In one embodiment of the SDV system shown in FIG. 1, a subscriber uses the set-top box 110 to request a content stream to view on the television 150. The SDV server 170 receives the request for the content stream from the SDV subsystem 120 of the set-top box 110. When the content stream is available, the SDV server 170 will bind a session to the edge router 160 for delivery of the content stream. The edge router 160 then delivers the content stream, as MPEG-2 transport stream over QAM 161, to the tuner 140 which will display the content stream on the television 150.

The advertisement replacement detector 130 shown in FIG. 1 monitors the content streams that the tuner 140 receives in order to detect an opportunity for advertisement replacement. In one embodiment, the advertisement replacement detector 130 detects a trigger in the content stream that indicates that an advertisement transition will occur, where the advertisement server 180 inserted the trigger into the content stream, and the SDV server 170 forwarded the content stream with the trigger to the set-top box 110 via the edge router 160. In another embodiment, the advertisement replacement detector 130 detects a splice point in the content stream that indicates that an advertisement transition will occur. Regardless of the technique to use to detect an advertisement period, when such an advertisement replacement opportunity occurs, the advertisement replacement detector 130 accesses storage 123 and obtains the appropriate advertisements. As discussed above, advertisements chosen from storage 123 will preferably have an association to the currently-watched channel.

In one embodiment, the advertisement replacement detector 130 provides a list of N (e.g., N=25) most-recently watched channels to advertisement server 180. However, the N channels may be any combination of most-recently-watched channels, most frequently-watched channels, and user favorite channels. The N channels comprise a subset of all channels available to the set-top-box 110. In response advertisement server 180 provides advertisements associated with the N channels to detector 130. These advertisements are stored in storage 123.

In another embodiment, demographic information may also be provided to advertisement server 180 so that server 180 may better tailor the advertisements to particular information. For example, advertisement replacement detector 130 may provide subscriber characteristics and preferences (i.e., demographic information, timing information, identification information, purchasing preferences, and the like) to server 180 so that better tailored advertisements may be obtained.

In yet another embodiment, the advertisements are provided with a program association. The program association comprises a television program where the advertisement may be played. In this particular embodiment, advertisements may not be played in programs that they are not associated with.

In yet another embodiment, the advertisements are provided with a “use by” date. Advertisements past their “use by” date are removed from storage.

Downloading advertisements is dynamic and may take place at any point, even during the watching of a particular channel. The download criteria are configurable and may include one or more of the following:
Stop downloading advertisement for current channel when a user switches to a new channel.
When an advertisement is associated with multiple channels, download only one instance of the advertisement.
When scheduling an advertisement download, prioritize downloading of advertisements for a particular channel based on the order the advertisements will be displayed.
When switching back to a previously viewed channel, resume download of advertisements that were stopped.

If replacement detector 130 determines that storage space is running low then one or more of the following steps may be taken.
Delete advertisements beyond their “use by” date.
Delete advertisements associated with channels that have not been viewed recently. In other words, keep the advertisements for the most-recently viewed channels.
Delete advertisements for channels not in the user's favorites list.
Delete advertisements for channels based on a user preference.
Delete advertisements for a channel that will free up most space from storage.

As discussed above, each advertisement has an associated channel(s) identifier. The advertisement replacement detector 130 determines the currently-watched channel and prepares associated advertisements to present to the subscriber. The SDV server 170 sends a tune data 173 message to the SDV subsystem 120 to provide the tuning information to the set-top box 110. In one embodiment, the tune data 173 message includes timing information to synchronize the set-top box 110 tune with the playing of the replacement target advertisement that the advertisement replacement detector 130 provides as an advertisement replacement stream to SDV subsystem 120, which provides it to tuner 140 at the appropriate time.

As discussed, when advertisements are fetched and stored locally, a problem exists in that storage 123 has limited storage capabilities. Because of this, only a limited number of advertisements can be locally stored. It becomes critical for the local storage to store advertisements that have a high probability of being viewed so that storage space is not wasted on advertisements that will not be viewed. In order to address this issue, a method and apparatus for managing advertisements in storage 123 will be utilized that downloads and maintains advertisements for multiple channels when user is viewing Linear TV. Advertisements will be removed from storage 123 when necessary.

Prior to discussing the management of advertisements in storage 123, the following definitions provide background information:
Channel list—A list of channels for which advertisements are being stored. Typically the channel list comprises the last N channels that were viewed by the user(s) of set-top box 110. N can be set to any number, depending upon the capacity of storage 123. A typical value for N is 25. N may have a maximum limit that is based on the capacity of storage 123.

Advertisement replacement detector 130 maintains the channel list in storage 123. The channel list is constantly updated by detector 130 with channels that the user watches, with channels constantly being added and removed from the list. If a currently-watched channel is already on the channel list, then a check may be made by detector 130 to see if the advertisements stored for that channel are still valid (e.g., are any advertisements associated with a current program). If the stored advertisements are valid, then no further action is taken by detector 130. If, however, the stored advertisements are not associated with the currently-watched program and/or channel, then they are deleted and the advertisements for the current program in channel are fetched from advertisement server 180. On the other hand, if the currently-watched channel was not in the channel list, detector 130 ads the channel to the channel list and the corresponding advertisements for currently-watched channel are fetched from server 180 and stored in storage 123.

The process above is repeated every time user tunes in to a channel. If the channel list reaches a maximum size, then the existing channels in the channel list may be deleted based on several channel deletion heuristics such deleting channels outside a user favorite lists, deleting channels based on a user preferences, keeping the most-recently-watched channels, . . . , etc. When a channel is removed from the channel list, the corresponding advertisements are also deleted.

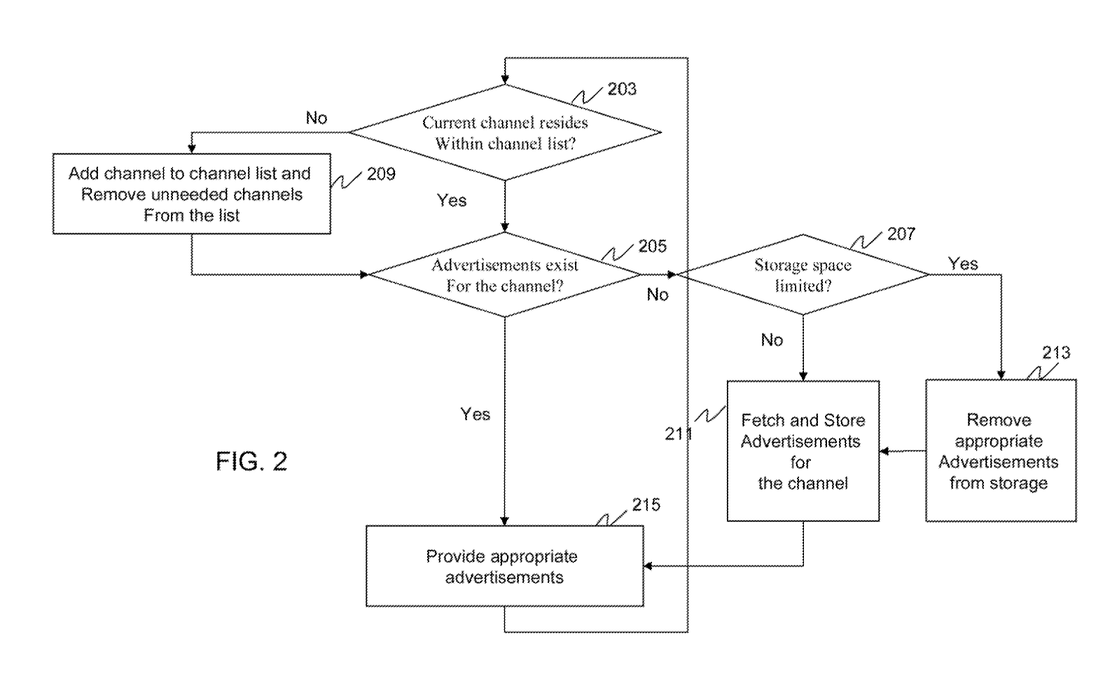

FIG. 2 is a flow chart showing operation of advertisement replacement detector 130. Prior to executing the steps of FIG. 2, the detector 130 maintains a list of N channels that comprise a subset of all channels available to the set-top-box 110. Identities for the N channels have been provided by detector 130 to server 180, and in response, server 180 has provided advertisements tailored to the N channels.

The logic flow begins at step 203 where detector 130 determines if the current channel resides within the list (N) of channels. If not, the logic flow continues to step 209 where the list is updated with the current channel, and stored in storage 123. As discussed above, if the channel list reaches a maximum size, then the existing channels in the channel list may be deleted based on several channel deletion heuristics. The logic flow then continues to step 205.

Continuing, if, at step 203 it is decided that the channel resides within the list of channels, the logic flow continues to step 205 where detector 130 determines if advertisements exist for the current channel (i.e., determines if advertisements are stored for the current channel). If advertisements exist for the current channel, the logic flow continues to step 215. If not, the logic flow continues to step 207 where detector 130 accesses storage 123 and determines if storage space is limited. If not, the logic flow continues to step 211, otherwise the logic flow continues to step 213. At step 213 appropriate advertisements are removed from storage. The logic flow continues to step 211 where detector 130 contacts server 180, provides the identity of the channel, and obtains and stores advertisements tailored for the channel. The logic flow continues to step 215 where the advertisements for the current channel are provided at the appropriate time. The logic flow then returns to step 203.

While the invention has been particularly shown and described with reference to a particular embodiment, it will be understood by those skilled in the art that various changes in form and details may be made therein without departing from the spirit and scope of the invention. It is intended that such changes come within the scope of the following claims:

1. A method for managing targeted advertisements for a linear television service, the method comprising the steps of:
maintaining a list of N channels, wherein the list of N channels comprises a subset of all channels available;
providing the N channels to an advertisement server;
receiving advertisements tailored to the N channels; and
storing the advertisements along with their associated channel.

2. The method of claim 1 wherein the list of N channels comprises a list of N most-recently-watched channels.

3. The method of claim 1 wherein the list of N channels comprises a combination of most-recently-watched channels and user favorite channels.

4. The method of claim 1 wherein the step of storing the advertisements comprises the step of storing the advertisements locally.

5. The method of claim 1 further comprising the steps of:
determining that advertisements are not stored for a channel;
providing an identity of the channel to the advertisement server; and
receiving advertisements tailored to the channel.

6. The method of claim 5 further comprising the steps of:
determining that storage space is limited; and
removing appropriate advertisements from storage.

7. The method of claim 6 wherein the step of removing the advertisements from storage comprises the steps of performing one or more of the following:
deleting advertisements beyond their “use by” date.
deleting advertisements associated with channels that have not been viewed recently. In other words, keep the advertisements for the most-recently viewed channels.
deleting advertisements for channels not in the user's favorites list.
deleting advertisements for channels based on a user preference.
deleting advertisements for a channel that will free up most space from storage.

8. The method of claim 1 further comprising the steps of:
determining that storage space is limited; and
removing appropriate advertisements from storage.

9. The method of claim 8 wherein the step of removing the advertisements from storage comprises the steps of performing one or more of the following:
deleting advertisements beyond their “use by” date.
deleting advertisements associated with channels that have not been viewed recently. In other words, keep the advertisements for the most-recently viewed channels.
deleting advertisements for channels not in the user's favorites list.
deleting advertisements for channels based on a user preference.
deleting advertisements for a channel that will free up most space from storage.

10. The method of claim 1 wherein the stored advertisements are a replacement for a primary network advertisements that are typically shown during a television program or between two television programs.

11. The method of claim 1 wherein the stored advertisements are used to fill time periods of program inactivity.

12. A device comprising:
storage maintaining a list of N channels, wherein the list of N channels comprises a subset of all channels available;
an advertisement replacement detector providing the N channels to an advertisement server, receiving advertisements tailored to the N channels, and storing the advertisements along with their associated channel.

13. The device of claim 12 wherein the list of N channels comprises a list of N most-recently-watched channels.

14. The device of claim 12 wherein the list of N channels comprises a combination of most-recently-watched channels, most frequently-watched channels, and user favorite channels.

15. The device of claim 12 wherein the step of storing the advertisements comprises the step of storing the advertisements locally within the storage.

16. The device of claim 12 wherein the advertisement replacement detector determines that advertisements are not stored for a channel, provides an identity of the channel to the advertisement server, and receives advertisements tailored to the channel.

17. The device of claim 16 wherein the advertisement replacement detector determines that storage space within the storage is limited and removes appropriate advertisements from storage.

18. The device of claim 17 wherein the advertisement replacement detector performs one or more of the following steps to remove the appropriate advertisements from storage:
delete advertisements beyond their “use by” date.
delete advertisements associated with channels that have not been viewed recently. In other words, keep the advertisements for the most-recently viewed channels.
delete advertisements for channels not in the user's favorites list.
delete advertisements for channels based on a user preference.
delete advertisements for a channel that will free up most space from storage.

19. The device of claim 12 wherein the advertisement replacement detector determines that storage space within the storage is limited and removes appropriate advertisements from storage.

20. The device of claim 19 wherein the advertisement replacement detector performs one or more of the following steps to remove the appropriate advertisements from storage:
delete advertisements beyond their “use by” date.
delete advertisements associated with channels that have not been viewed recently. In other words, keep the advertisements for the most-recently viewed channels.
delete advertisements for channels not in the user's favorites list.
delete advertisements for channels based on a user preference.
delete advertisements for a channel that will free up most space from storage.
